(19) United States
(12) Patent Application Publication
(10) Pub. No.: US 2003/0237021 A1
(43) Pub. Date: Dec. 25, 2003

(54) Automatic restoration of software applications in a mobile computing device

(76) Inventors: Yee Fen Ching, Singapore (SG); Kok Yong Raymond Chow, Singapore (SG); Denny Roberty Iriawan, Singapore (SG); Hong Meng Oh, Singapore (SG)

Correspondence Address: HEWLETT-PACKARD COMPANY, Intellectual Property Administration, P.O. Box 272400, Fort Collins, CO, 80527-2400, US

(21) Appl. No.: 10/177,877

(22) Filed: Jun. 20, 2002

(51) Int. Cl. H02H 3/05

(52) U.S. Cl. 714/15

(57) ABSTRACT

A method for automatic restoration of software applications in mobile computing devices is provided. Typically, when a power loss occurs on a mobile computing device, contents in the volatile memory are lost. Due to the loss in volatile memory content, applications are generally rendered non-operational. A user of the device has to reinstall the applications to fully restore functionality of the applications. With the present invention, such applications are automatically and fully restored without user intervention. To this end, essential files and settings residing in a volatile memory are complied and stored in a non-volatile memory. When power resumes following a power loss, the essential files and settings are automatically located and installed to the volatile memory to restore functionality to the applications.

### BACKGROUND OF THE INVENTION

1. Field of the Invention.

The present invention relates to recovering applications after a power loss. More particularly, it relates to a method of automatic restoration of applications on a power restoration after a power loss in a mobile computing device.

2. Description of Background Information.

Personal Digital Assistants (PDAs) or handhelds have increasingly been replacing standard organizers because PDAs provide much more functionality than a standard organizer. Applications that were once available only to bulky computer systems are now available to PDAs due to advancement in microprocessor and memory technologies. Apart from standard personal information management applications, PDA users can choose from an extensive range of applications, including business solutions, entertainment, personal information management and financial management.

Despite the advancement in memory technologies, costs and the requirement for small form factor constrain memory storage capacity of PDAs. Typically, PDAs contain a non-volatile memory such as a Read Only Memory (ROM), flash ROM and Electrically Erasable Programmable ROM (EEPROM). The advantage of a non-volatile memory is persistent data retention even in the event of a power loss. PDAs also contain a volatile memory such as a Random Access Memory (RAM), which requires a constant power supply. When power is disrupted, RAM contents are lost. Any application installed in the RAM prior to the power disruption needs to be reinstalled to render the application operational again. Applications installed in the ROM, however, remain usable after the power disruption because installed files in the ROM are retained. However, the applications installed in the ROM cannot be removed subsequently by a user. Any changes required in the applications pre-built in the ROM require an entire ROM image to be rebuilt.

While it is possible to pre-build applications in a rewritable non-volatile memory such as a flash ROM to provide flexibility for both application removal and data retention, certain files and settings are still required to reside in RAM. Hence, the need for user reinstallation of the application to restore RAM contents still arises after a power loss.

In view of the prior art, there is a need for a method of automatically restoring an application to a state of full functionality on power restoration after a power loss. The solution should also achieve efficient use of memory storage by customizing applications to the needs of users.

### SUMMARY OF THE INVENTION

The present invention relates to a method of recovering applications after power loss and automatically restoring the applications when power resumes. Preferably, the present invention is implemented on a non-volatile memory, such as a flash ROM, that allows read and write functions.

In a mobile computing device, files and settings of installed applications typically reside in both volatile and non-volatile memories. In a prior art device, an unexpected power loss causes the erasure of volatile memory contents, including files and settings essential to the operation of the application. This erasure renders the application unusable.

According to a first aspect of the invention, a method of preparing essential files for enabling automatic full restoration of an application is provided. The essential files include an installation file, which self-executes for restoring RAM contents corresponding to the application on a power restoration. The installation file comprises pre-specified installed files and settings for installation to designated RAM locations. The essential files may also include an uninstallation file containing a list of installed files for removal during uninstallation of the application to ensure complete uninstallation of the application.

The essential files described in accordance with the first aspect of the invention are utilized when there is a power restoration after a power loss, or upon a cold boot. According to a second aspect of the invention, upon a power restoration or a cold boot, a program self-initiates to locate the essential files, more particularly the installation file. The installation file self-executes to install RAM contents for restoring the application. With the present invention, prior art applications may be adapted to be automatically restorable.

According to a third aspect of the invention, a method is provided for pre-building into a rewritable non-volatile memory an application or a selection of applications that are automatically restorable after a power loss.

### BRIEF DESCRIPTION OF THE DRAWINGS

The present invention will be described with reference to the accompanying drawings, in which:

FIG. 1 is a representation of a non-volatile memory in a mobile computing device.

FIG. 2 describes a flowchart sequence in accordance with a first aspect of the present invention on preparation of essential files for enabling automatic full restoration of an application after a power loss.

FIG. 3 describes a flowchart sequence in accordance with a second aspect of the present invention on operation of the present invention when there is a power restoration after a power loss.

FIG. 4 describes a flowchart sequence according to a third aspect of the present invention on a method of pre-initializing a non-volatile memory for pre-building removable and restorable applications.

### DETAILED DESCRIPTION

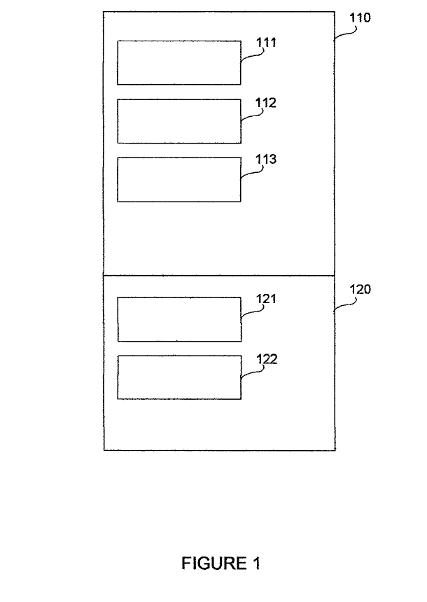

The present invention may be implemented on a non-volatile memory that allows read and write, such as a flash ROM or EEPROM. To illustrate the present invention, the invention is described in the context of mobile computing devices such as PDAs, where volatile memories may be RAMs, and non-volatile memories (NVMs) may be partitioned into a first 110 and a second 120 file system area as shown in FIG. 1. The first file system area 110 is a Read-Only-Memory (ROM), readable but not rewritable. It typically contains the operating system (OS) 111 and pre-built applications (112 and 113), if any, which are not removable from the first file system area 110. The second file system area 120 is readable and rewritable. It may contain user-created files and installed files of applications and usually appears to a user as a folder or directory as known in the art.

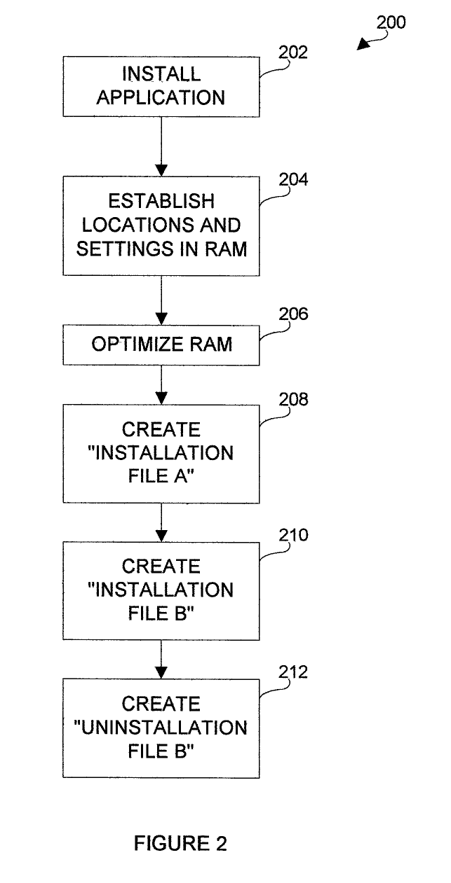

Reference is now made to FIG. 2, where a flowchart sequence 200 describes a first aspect of the invention on preparation of essential files for enabling automatic full restoration of an application after a power loss. The preparation of essential files may be performed using prior art applications installable in a mobile computing device.

The sequence 200 begins with an INSTALL APPLICATION step 202, where an application is installed into the second file system area 120 of the mobile computing device. When the installation is completed, installed files reside in both the second file system area 120 of the non-volatile memory and in the RAM as known to a person skilled in the art. Settings for operating the application are also written into the RAM. Installed files and settings residing in the volatile memory will be hereinafter referred to as RAM-resident files, and installed files residing in the non-volatile memory (NVM) will be referred to as NVM-resident files.

A snapshot of the installation is obtained in an ESTABLISH LOCATIONS AND SETTINGS IN RAM step 204. The snapshot comprises information on prescribed properties of installed files residing in the volatile memory, including locations (or addresses) in RAM where the installed files are residing, and settings required for operating the application. During automatic restoration of the application upon power restoration, the established information is necessary to restore specified contents into designated locations to render the application usable.

When the locations and settings have been established, the RAM storage may be optimized in an OPTIMIZE RAM step 206. Typically, when an application is installed, the installed files reside in both the second file system area 120 of the non-volatile memory and in the RAM. Among the RAM-resident files, some files are required to reside in the RAM, while other files may be stored in any of the non-volatile memory and RAM. In order to optimize and free up RAM resources for other applications, some RAM-resident files may be copied into the non-volatile memory instead while still rendering the application operational. In this OPTIMIZE RAM step 206, RAM-resident files that can alternatively reside in a non-volatile memory are identified in a manner known in the art, or by trial and error. When identification is completed, files that can alternatively be stored in the non-volatile memory are copied to the non-volatile memory. Subsequently, lists of RAM-resident files and NVM-resident files are obtained and are utilized subsequently in latter steps.

The OPTIMIZE RAM step 206 then proceeds to a CREATE “INSTALLATION FILE A” step 208. “Installation File A” is an installation file comprising pre-specified RAM-resident files and RAM settings obtained from the ESTABLISH LOCATIONS AND SETTINGS IN RAM step 204 and the OPTIMIZE RAM step 206. In the event of a power loss, “Installation File A” self-executes to restore the RAM contents associated with the application into the designated locations for fully restoring the application. The “Installation File A” has to be resistant to power loss and is therefore stored in the non-volatile memory.

The CREATE “INSTALLATION FILE A” step 208 then proceeds to a CREATE “INSTALLATION FILE B” step 210. “Installation File B” is an installation file comprising all installed files and settings associated with the application, including RAM-resident files, RAM settings and NVM-resident files.

As known in the art, whenever an installation file is executed, an associated uninstallation file is generated. The uninstallation file contains a list of files and settings to be removed from the respective memory when a user wants to uninstall or remove an application. To further illustrate this concept as applied in the present invention, an “Uninstallation File A” contains a list of pre-specified RAM-resident files and settings to be removed from the RAM during an uninstallation or removal of the application. An “Uninstallation File B” contains a list of pre-specified RAM-resident files and settings to be removed from the RAM during uninstallation (like in “Uninstallation File A”), and also a list of non-volatile resident files to be removed from the non-volatile memory. Whenever a user wants to remove an application, activating “Uninstallation File B” for uninstallation ensures a complete removal of the application, while activating “Uninstallation File A” results in a partial removal of the program, i.e., removal of RAM-resident files only.

The purpose of creating “Installation File B” is to generate an “Uninstallation File B” which ensures a complete removal of the application. Hence, “Installation File B” is an intermediate file which does not need to be eventually stored in the non-volatile memory with the application. The “Uninstallation File B” is created in a CREATE “UNINSTALLATION FILE B” in step 212 and stored in the non-volatile memory. The “Uninstallation File B” also includes “Installation File A” so that the “Installation File A” is also removed during application uninstallation.

In accordance with the present invention, an “Installation File A” for restoring an application and an “Uninstallation File B” for uninstalling the application are stored with executable files or any associated files for operating the application, preferably in the same directory. The utilization of the “Installation File A” and the “Uninstallation File B” in accordance with the present invention and the advantages of the present invention will be apparent in the following paragraphs.

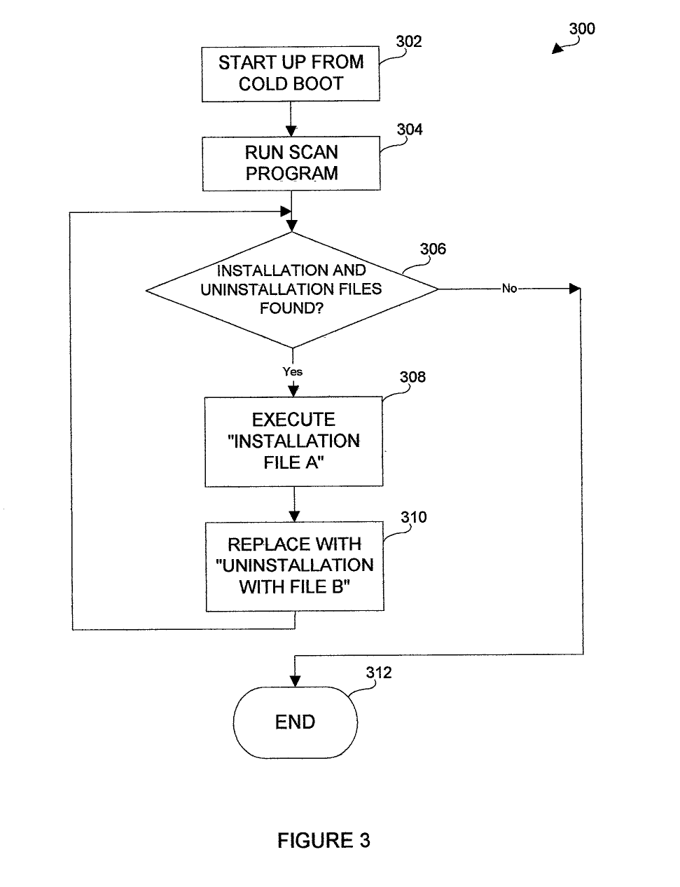

Reference is now made to FIG. 3, where a flowchart sequence 300 describes a second aspect of the invention on automatically restoring application when there is a power restoration after a power loss, or when there is a cold boot, or when a user boots up a computing device for a first time. Performance of the sequence 300 is initiated automatically and would be transparent to a user.

A computing device starts up from an non-initialized state in a COLD BOOT step 302. COLD BOOT step 302 then proceeds to a RUN SCAN PROGRAM step 304. A scan program, residing in the non-volatile memory, self-initiates on each cold boot. The scan program searches in directories of the second file system area 120 for installation files and associated uninstallation files. If no installation file or uninstallation file is located, the RUN SCAN PROGRAM step 304 proceeds through an INSTALLATION AND UNINSTALLATION FILES FOUND? step 306 to an END step 312, where the sequence 300 ends.

If an installation file is located, the scan program searches for an associated uninstallation file. When both files are located, restoration of the application is carried out in accordance with the present invention in an EXECUTE “INSTALLATION FILE A” step 308. In this step, the “Installation File A” of the application then self-executes to restore pre-specified contents to designated locations in the RAM. The pre-specified contents include files and settings determined in the first aspect of the invention. A notification window may be displayed to inform a user that automatic restoration of an application is taking place. When the files and settings are restored to the RAM, the application is fully operational.

When the “Installation File A” is executed, an associated uninstallation file, i.e., “Uninstallation File A” is automatically generated. This newly generated uninstallation file contains a list of RAM-resident files and RAM settings to be removed during uninstallation. If a user were to now remove the application using the newly generated uninstallation file, i.e., “Uninstallation File A”, only the RAM-resident files will be removed while NVM-resident files will remain. To ensure a complete removal of the application when there is an uninstallation subsequently, the newly generated uninstallation file is replaced by the “Uninstallation File B” residing in the non-volatile memory in a REPLACE WITH “UNINSTALLATION FILE B” step 310.

Thereafter, the sequence loops back to INSTALLATION AND UNINSTALLATION FILES FOUND? step 306 to search for other installation and uninstallation files of other applications. If installation files and uninstallation files of other applications are located, the EXECUTE “INSTALLATION FILE A” step 308 and REPLACE WITH “UNINSTALLATION FILE B” step 310 are repeated for that application. Otherwise, the flowchart sequence 300 proceeds to an END step 312. Other files associated with the applications and residing in the non-volatile memory are retained unmodified.

In the INSTALLATION AND UNINSTALLATION FILES FOUND step 306, both “Installation File A” and “Uninstallation File B” of an application must be located before the “Installation File A” self-executes. This is done to ensure that only installation files associated with a restorable application are executed. An alternative action in the INSTALLATION AND UNINSTALLATION FILES FOUND step 306 is to locate only “Installation File A.” To avoid executing any installation files in the non-volatile memory not associated with a restorable application according to the present invention, a further check may be adopted before executing the file to ensure that each installation file located associated with a restorable application.

In prior art computing devices, the second file system area 120 is generally uninitialized when a computing device containing the non-volatile memory is first started up by a user. Even if it were initialized, the second file system generally would not have contained any applications, since certain application files and settings are required to be installed in the RAM. On the first boot up, the RAM is empty and any application files residing in the rewritable nonvolatile memory will not be usable. Further, applications are preferably customized according to the needs of a user group. With the present invention, applications can now be customized and pre-built in the second file system area 120 of the nonvolatile memory, and are subsequently removable and fully restorable after a power loss.

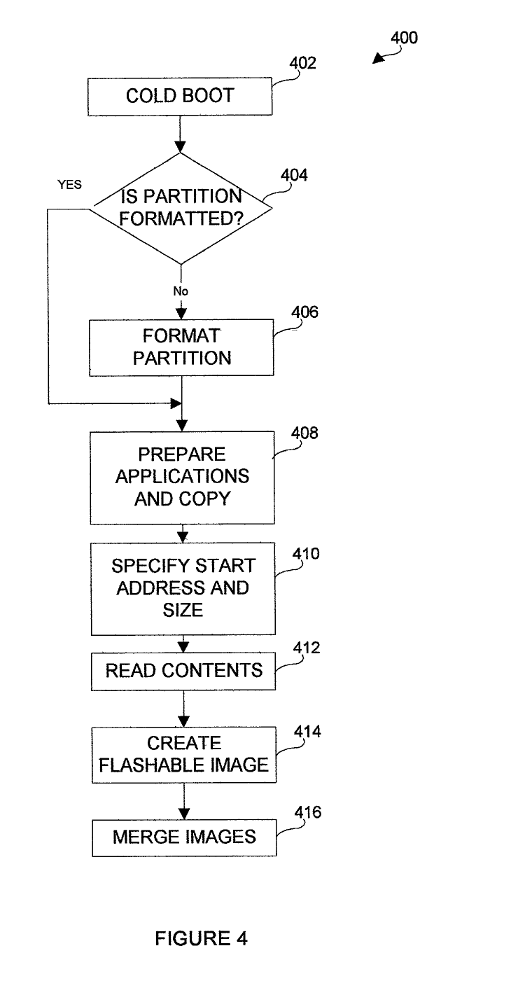

FIG. 4 illustrates a flow sequence 400 according to a third aspect of the present invention on a method of pre-initializing a non-volatile memory for pre-building removable and fully restorable applications.

The sequence 400 begins with a COLD BOOT step 402, where a non-volatile memory boots up. The non-volatile memory is divided into two partitions corresponding to the first 110 and the second 120 file system area. At this stage, the first file system area 110 contains the operating system 111 and non-removable pre-built applications (112, 113). While the second file system area 120 is empty, the COLD BOOT step 402 then proceeds to an IS PARTITION FORMATTED? decision step 404, where it is determined whether the partition (the second file system area 120) is formatted or not. This step may be carried out by an Installable File System (IFS) in the OS driver. If the partition is formatted or valid, the sequence 400 proceeds to a PREPARE APPLICATIONS AND DATA step 312. If the partition is determined as unformatted or invalid, the sequence 400 proceeds to a FORMAT PARTITION step 406, where a flash driver formats the partition. When formatting of the partition is complete, a formatted partition corresponding to the second file system area 120 is created and appears to a user as a folder or directory.

The FORMAT PARTITION step 406 then proceeds to a PREPARE APPLICATIONS AND COPY step 408. According to the profile of a targeted user, a selection of applications software is customized and prepared. According to the first aspect of the invention, an “Installation File A” and an “Uninstallation File B” are also prepared for each application. Files for the selected applications, including an “Installation File A” and an “Uninstallation File B,” are then copied into the second file system area 120. Thereafter, the start address and size of the second file system area 120 are established in a SPECIFY START ADDRESS AND SIZE step 410 to determine the size and boundary of the second file system area 120. The second file system area 120 now contains files of the various applications required by a targeted user. With the start address of the second file system 120, the contents of the second system area 120 are now read in a READ CONTENTS step 412. The contents read therefrom are used to create a flashable image in a CREATE FLASHABLE IMAGE step 414.

The flashable image of the second file system area 120 is then merged with an image of the contents in the first file system area in a MERGE IMAGES step 416. The merged image may then be used to pre-initialize other non-volatile memories for containing same restorable applications.

When a user receives a computing device containing a non-volatile memory pre-initialized according to the third aspect, the non-volatile memory contains applications which are automatically restorable on a power restoration after a power loss. They are also completely removable by subsequent uninstallation. When the user first boots up the device, the applications are automatically restored according to the second aspect of the invention.

What is claimed is:

1. A method of automatically restoring an application after a power loss in a mobile computing device embodying the application, the device having a non-volatile memory and a volatile memory, comprising:
self-initiating locating a first file in the non-volatile memory on a power restoration after the power loss; and
self-executing the first file containing pre-specified contents for installation to the volatile memory.

2. The method according to claim 1 further comprising:
generating an associated file on self-executing the first file, the associated file containing a list of installed files residing in the volatile memory for removal during an application uninstallation.

3. The method according to claim 2 wherein
self-initiating locating further includes locating a second file, the second file containing a list of installed files residing in the nonvolatile and the volatile memory; and
the method further comprising:
replacing the associated file with the second file.

4. The method according to claim 3 wherein the list contained in the second file further includes the first file.

5. A mobile computing device capable of automatically restoring an application after a power loss, the device having a non-volatile memory and a volatile memory readable by a microprocessor, comprising:
a first file residing in the non-volatile memory; and
a self-initiated means for locating the first file upon a power restoration after the power loss, wherein the first file self-executes for installing pre-specified contents to the volatile memory.

6. The mobile computing device according to claim 5 further comprising a second file containing a list of installed files residing in the nonvolatile and the volatile memory wherein the installed files in the list are removed during an application uninstallation.

7. The mobile computing device according to claim 6 wherein the list contained in the second file further includes the first file.

8. The mobile computing device according to claim 7 wherein an associated file is generated when the first file self-executes, and the associated file is replaced with the second file.

9. A method of preparing an application which is automatically restorable after a power loss in a mobile computing device embodying the application, the device having a non-volatile memory and a volatile memory, comprising:
installing the application in the device;
establishing prescribed properties of installed contents in the volatile memory; and
creating a first file containing the established properties of installed contents for installation to the volatile memory, wherein on a power restoration after the power loss, the first file self-executes to restore the installed contents to the volatile memory.

10. The method according to claim 9 wherein establishing prescribed properties of installed contents in the volatile memory includes establishing settings and locations of installed contents.

11. The method according to claim 10 further comprising creating a second file containing a list of installed files residing in the volatile and the non-volatile memories, wherein the installed files in the list are removed during an application uninstallation.

12. A method of pre-initializing a non-volatile memory for containing an application automatically restorable after a power loss in a mobile computing device, the device also containing a volatile memory, comprising:
copying files into the non-volatile memory for operating the application; and
copying a first file into the non-volatile memory, wherein on a power restoration after the power loss, the first file containing pre-specified contents self-executes for installation to the volatile memory.

13. The method according to claim 12 further comprising copying a second file, the second file comprising a list of installed files residing in the non-volatile and the volatile memory, wherein the installed files in the list are removed during an application uninstallation.

14. A non-volatile memory in a mobile computing device containing an application automatically restorable after a power loss, wherein the non-volatile memory is pre-intialized by a method comprising:
copying files into the non-volatile memory for operating the application; and
copying a first file into the non-volatile memory, wherein on a power restoration after the power loss, the first file containing pre-specified contents self-executes for installation to the volatile memory.

15. The non-volatile memory according to claim 14 pre-initialized by the method further comprising copying a second file, the second file comprising a list of installed files residing in the non-volatile and the volatile memory, wherein the installed files are removed during an application uninstallation.
